(19) United States
(12) Patent Application Publication
(10) Pub. No.: US 2026/0172525 A1
(43) Pub. Date: Jun. 18, 2026

(54) RECEIVER FOR ENSURING CONTINUITY, TRANSCEIVER INCLUDING THE SAME AND METHOD

(71) Applicant: SAMSUNG ELECTRONICS CO., LTD., Suwon-si (KR)

(72) Inventors: Han-Soo SEONG, Suwon-si (KR); Jooyong PARK, Suwon-si (KR)

(73) Assignee: SAMSUNG ELECTRONICS CO., LTD., Suwon-si (KR)

(21) Appl. No.: 19/414,709

(22) Filed: Dec. 10, 2025

(30) Foreign Application Priority Data
Dec. 12, 2024 (KR) 10-2024-0184829

(51) Int. Cl. H04N 7/035; H04B 1/40; H04L 25/03

(52) U.S. Cl. CPC H04N 7/0352; H04B 1/40; H04L 25/03

(57) ABSTRACT

A transceiver includes a transmitter and a receiver. The transmitter is configured to (i) acquire a valid signal indicating occurrence of a rising edge and a falling edge of an input event signal and an event data signal indicating a type of edge, based on the rising edge and the falling edge, (ii) acquire a stamp signal indicating a transmission counter value corresponding to the valid signal, among transmission counter values, and (iii) transmit the valid signal, the event data signal, and the stamp signal. The receiver is configured to (i) buffer the valid signal, the event data signal, and the stamp signal in a buffer, (ii) acquire a reception counter value corresponding to the stamp signal, among reception counter values, and (iii) perform a retrieval operation on the buffer at a time point corresponding to the reception counter value.

### CROSS-REFERENCE TO RELATED APPLICATION(S)

This U.S. non-provisional application claims priority under 35 USC § 119 to Korean Patent Application No. 10-2024-0184829, filed on Dec. 12, 2024, in the Korean Intellectual Property Office, the disclosure of which is herein incorporated by reference in its entirety.

### BACKGROUND

The present disclosure relates to a receiver for ensuring continuity, a transceiver including the same, and a method.

Unlike the past where devices such as televisions (TVs) were limited to broadcasting functions, the role of video output devices has gradually expanded over time. For example, there is growing demand for functionalities that integrate Internet connectivity, applications, and other technologies to provide home entertainment-centric content such as gaming, fitness, or the like. Video output devices may receive digital data from broadcasting, Internet, or other sources and generate and process video data from the received digital data to provide various contents.

Continuous video signals are used to process image data. Continuity needs to be ensured for the continuous video signals. However, when a distance of a channel through which the continuous video signals are transmitted and received is long, continuity may be degraded.

### SUMMARY

One or more embodiments provide a receiver for ensuring continuity, a transceiver including the same, and a method.

According to one or more embodiment, a transceiver includes a transmitter configured to acquire a valid signal indicating occurrence of a rising edge and a falling edge of an input event signal and an event data signal indicating a type of edge, based on the rising edge and the falling edge, acquire a stamp signal indicating a transmission counter value corresponding to the valid signal, among transmission counter values, and transmit the valid signal, the event data signal, and the stamp signal, and a receiver configured to buffer the valid signal, the event data signal, and the stamp signal in a buffer, acquire a reception counter value corresponding to the stamp signal, among reception counter values, and perform a retrieval operation on the buffer at a time point corresponding to the reception counter value.

According to one or more embodiments, a receiver includes a reception interface configured to receive a valid signal indicating occurrence of a rising edge and a falling edge of an input event signal, an event data signal indicating a type of edge, and a stamp signal indicating a transmission counter value corresponding to the valid signal, a reception counter configured to sequentially acquire reception counter values, and a buffer configured to buffer the valid signal, the event data signal, and the stamp signal and perform a retrieval operation at a time point corresponding to a reception counter value corresponding to the stamp signal, among the reception counter values.

According to one or more embodiments, a method of a receiver includes receiving a valid signal indicating occurrence of a rising edge and a falling edge of an input event signal, an event data signal indicating a type of edge, and a stamp signal indicating a transmission counter value corresponding to the valid signal, buffering the valid signal, the event data signal, and the stamp signal, sequentially acquiring reception counter values, and performing a retrieval operation at a time point corresponding to a reception counter value corresponding to the stamp signal, among the reception counter values.

### BRIEF DESCRIPTION OF DRAWINGS

FIG. 1 is a block diagram of a transceiver according to one or more embodiments.

FIG. 2 is a block diagram of a transmitter of FIG. 1, according to one or more embodiments.

FIG. 3 is a block diagram of a receiver of FIG. 1, according to one or more embodiments.

FIG. 4 is a timing diagram of the operation of a transmitter according to one or more embodiments.

FIG. 5 is a timing diagram of the operation of a receiver according to one or more embodiments.

FIG. 6 is a block diagram of a transceiver according to some example embodiments.

FIG. 7 is a timing diagram of a valid signal acquisition operation of the transmitter of FIG. 6, according to one or more embodiments.

FIG. 8 is an operation timing diagram of counters in the transceiver of FIG. 6 according to one or more embodiments.

FIG. 9 is a block diagram of a receiver according to one or more embodiments.

FIG. 10 is a timing diagram of signals transmitted and received through an exemplary channel.

FIG. 11 is a timing diagram of signals transmitted and received through a transceiver according to one or more embodiments.

FIG. 12 is a flowchart illustrating a method of operating a transmitter according to one or more embodiments.

FIG. 13 is a flowchart illustrating a method of operating a receiver according to one or more embodiments.

FIG. 14 is a diagram illustrating a display device according to one or more embodiments.

### DETAILED DESCRIPTION

Hereinafter, one or more embodiments will be described with reference to the accompanying drawings.

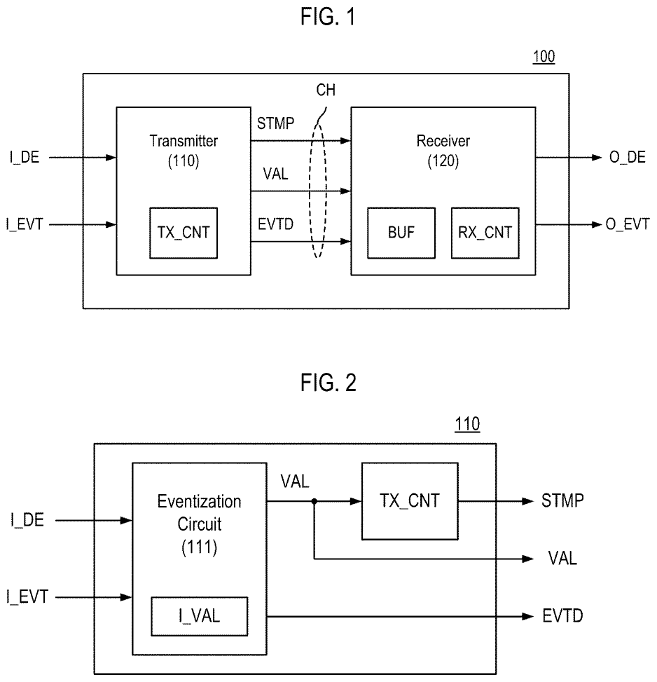

FIG. 1 is a block diagram of a transceiver according to one or more embodiments.

Referring to FIG. 1, a transceiver 100 according to one or more embodiments may include a transmitter 110 and a receiver 120 connected to each other through a channel CH.

According to certain embodiments, the transmitter 110 and the receiver 120 may each correspond to a unit module (or block) or be included in a unit module. Each unit module may transmit and receive image data to and from each other or process the transmitted and received image data, and may be implemented in hardware or a combination of hardware and software. For example, each unit module may decode digital data received through high-definition multimedia interface (HDMI), universal serial bus (USB), the Internet, or broadcasting to generate image data, process image data, perform an operation to improve picture quality (PQ) of image data, or perform an operation to output image data.

In certain embodiments, the transmitter 110 may be provided with (e.g., receive) an input data enable signal I_DE and an input event signal I_EVT. In the present application, an “event signal” may also be referred to as an on-the-fly (OTF) signal. The event signal may be a continuous video signal used to process image data. For example, the event signal may include a vertical synchronization signal, a horizontal synchronization signal, or the like. The vertical synchronization signal may be a video control signal for synchronizing frames of image data and indicate timing (for example, start timing) of each frame period. The horizontal synchronization signal may be a video control signal for horizontal synchronization within the same frame of image data and indicate the timing (for example, start timing) of each horizontal time within the frame.

The input data enable signal I_DE may indicate validity of image data. For example, the input data enable signal I_DE may indicate the start or end of a valid period of certain image data. For example, when the input data enable signal I_DE indicates a specific logic level (for example, logic high), the image data corresponding to the input data enable signal I_DE may be valid.

In certain embodiments, the transmitter 110 may acquire (or generate) a valid signal VAL and an event data signal EVTD based on a rising edge and a falling edge of the provided input event signal I_EVT. For example, the transmitter 110 may first acquire (or generate) an internal valid signal that toggles at each rising edge and falling edge of the input event signal I_EVT. For example, each pulse of the internal valid signal may indicate either a rising edge or a falling edge of each pulse appearing in the input event signal I_EVT. The transmitter 110 may acquire (or generate) the valid signal VAL based on an OR operation on the input data enable signal I_DE and the internal valid signal. As a result, the valid signal VAL may indicate logic high during a period in which at least one of the input data enable signal I_DE or the internal valid signal has logic high. Thus, the valid signal VAL may indicate the occurrence of rising and falling edges and indicate that the image data is valid.

In addition, the transmitter 110 may acquire (or generate) an event data signal EVTD indicating which type of edge, either rising edge or falling edge, each pulse included in the valid signal VAL corresponds to. For example, the event data signal EVTD is configured to indicate the type of edge for each of the pulses included in the valid signal VAL.

In certain embodiments, the transmitter 110 may include a transmission counter TX_CNT. The transmission counter TX_CNT may be configured to sequentially acquire (or generate) transmission counter values. The transmitter 110 may acquire a stamp signal STMP indicating a transmission counter value corresponding to the valid signal VAL, among transmission counter values. The stamp signal STMP may be defined as a signal that provides the same timing between the transmitter 110 and the receiver 120. The stamp signal STMP may indicate a transmission counter value corresponding to a specific logic level period (for example, a logic high period) of the valid signal VAL. For example, the stamp signal STMP may indicate what the transmission counter value is at a time point at which an event (for example, a toggle) is detected in the input event signal I_EVT, or at which valid video data is detected based on the input data enable signal I_DE.

In certain embodiments, the transmission counter TX_CNT may be initiated based on a reset signal, common to the transmitter 110 and the receiver 120, transitioning to a specific logic level (for example, logic high). For example, the transmission counter TX_CNT may acquire (or generate) transmission counter values when the reset state is released.

The transmitter 110 transmits the valid signal VAL, the event data signal EVTD, and the stamp signal STMP acquired (or generated) according to the above-described embodiments to the receiver 120 through the channel CH. As a physical distance of the channel CH increases, an issue ‘data transfer delay’ may occur at the receiver 120, where some data is lost from the received signal or phases of some pulses are mismatched. Such a data transfer delay may be problematic in signals where continuity should be ensured, for example, OTF signals. When data transfer delay occurs, a reception time point of the received signal is variable, unlike the stamp signal STMP transmitted in accordance with the valid signal VAL.

In certain embodiments, the receiver 120 may receive the valid signal VAL, the event data signal EVTD, and the stamp signal STMP transmitted from the transmitter 110 through the channel CH. A portion of the received signals may experience a data transfer delay depending on the channel CH. The receiver 120 may buffer the valid signal VAL, the event data signal EVTD, and the stamp signal STMP in a buffer BUF. The buffer BUF is configured to buffer the received signals and may have, for example, a first-in-first-out (FIFO) structure. However, embodiments are re not limited thereto.

In certain embodiments, the receiver 120 may include a reception counter RX_CNT configured to sequentially acquire reception counter values. The receiver 120 may acquire a reception counter value corresponding to the stamp signal STMP, among the reception counter values. For example, the receiver 120 may acquire a value that is equal to the transmission counter value indicated by the stamp signal STMP, among the reception counter values. For example, the stamp signal STMP may be used to synchronize timing with the transmitter 110 on the side of the receiver 120.

The receiver 120 may perform a retrieval operation from the buffer BUF at a time point corresponding to the acquired reception counter value. For example, the receiver 120 may retrieve at least one of the buffered valid signal VAL, event data signal EVTD, or stamp signal STMP from the buffer BUF at the time point corresponding to the acquired reception counter value.

In certain embodiments, the reception counter RX_CNT may be initiated based on the first stamp signal STMP received after a reset signal, common to the transmitter 110 and receiver 120, transitions to a specific logic level (for example, logic high). Unlike the transmission counter TX_CNT operating immediately after the reset state is released, the reception counter RX_CNT may be initiated based on a first stamp signal STMP received first by the receiver 120 after the reset state is released. For example, the reception counter RX_CNT may be initiated from a value delayed by a predetermined value from the transmission counter value indicated by the first stamp signal STMP. The predetermined value may be an integer. For example, when the predetermined value is a negative integer, the first reception counter value output based on the initiation of the reception counter RX_CNT may be a value advanced by the predetermined value from the transmission counter value indicated by the first stamp signal STMP.

According to the above-described embodiments, a time point at which the reception counter RX_CNT is initiated may be delayed by a predetermined value, relatively to the transmission counter TX_CNT, and a time point at which the receiver 120 performs a retrieval operation from the buffer BUF may also be adjusted based on the delay. For example, even when the received signal is delayed, the initiation time point of the reception counter RX_CNT may also be delayed, ensuring the continuity of the retrieval operation. Additionally, when a signal is received earlier, only the amount of buffered data may increase, which does not affect the continuity of the retrieval operation.

The receiver 120 may retrieve the event data signal EVTD from the buffer BUF through the retrieval operation according to the above-described embodiments and acquire (or generate) an output event signal O_EVT based on the event data signal EVTD. Alternatively, the receiver 120 may decode the event data signal EVTD to acquire (or generate) the output event signal O_EVT.

The receiver 120 may retrieve the valid signal VAL from the buffer BUF through the retrieval operation and acquire (or generate) an output data enable signal O_DE based on the valid signal VAL. Alternatively, the receiver 120 may decode the valid signal VAL to acquire (or generate) the output data enable signal O_DE.

The transceiver 100 according to the above-described embodiments may ensure the continuity of the retrieval operation on buffered signals through adjustment of the initiation time point of the reception counter RX_CNT to prevent data transfer delays for continuous video signals transmitted over longer-distance channels CH.

FIG. 2 is a block diagram of a transmitter of FIG. 1, according to one or more embodiments.

Referring to FIG. 2, the transmitter 110 may include an eventization circuit 111 and a transmission counter TX_CNT.

The eventization circuit 111 may be provided with (or receive) the input data enable signal I_DE and the input event signal I_EVT according to the above-described embodiments.

In certain embodiments, the eventization circuit 111 may acquire (or generate) an internal valid signal I_VAL based on the received input event signal I_EVT. The internal valid signal I_VAL may be defined as a signal that toggles at a rising edge and a falling edge of the input event signal I_EVT according to the above-described embodiments. The eventization circuit 111 may acquire (or generate) a valid signal VAL based on an OR operation between the input data enable signal I_DE and the internal valid signal I_VAL. The eventization circuit 111 may output the acquired (or generated) valid signal VAL.

In certain embodiments, the eventization circuit 111 may acquire (or generate) the event data signal EVTD according to the above-described embodiments based on the internal valid signal I_VAL. The eventization circuit 111 may output the acquired (or generated) event data signal EVTD.

The valid signal VAL and event data signal EVTD output through the eventization circuit 111 may allow the receiver 120 to determine which periods of the input event signal I_EVT and the input data enable signal I_DE are valid and how the logic level of the input event signal I_EVT transitions in the valid periods (for example, from logic high to logic low or from logic low to logic high).

The eventization circuit 111 may provide the valid signal VAL to the transmission counter TX_CNT. The transmission counter TX_CNT may sequentially acquire (or generate) transmission counter values and output the transmission counter value corresponding to the received valid signal VAL as a stamp signal STMP. For example, the transmission counter TX_CNT may output a counter value at a time point of occurrence as a stamp signal STMP whenever an event (for example, a rising edge or a falling edge) occurs in the input event signal I_EVT.

According to certain embodiments, the transmitter 110 may further include a stamp circuit, not illustrated, independently connected to the transmission counter TX_CNT and configured to acquire (or generate) and output the stamp signal STMP. The stamp circuit, not illustrated, may receive transmission counter values from the transmission counter TX_CNT and acquire (or generate) and output the stamp signal STMP indicating the transmission counter value corresponding to the valid signal VAL.

The transmitter 110 may provide the valid signal VAL and the event data signal EVTD, enabling the receiver 120 to decode the input event signal I_EVT. In addition, the transmitter 110 may provide the stamp signal STMP, enabling the receiver 120 to synchronize timing with the transmitter 110.

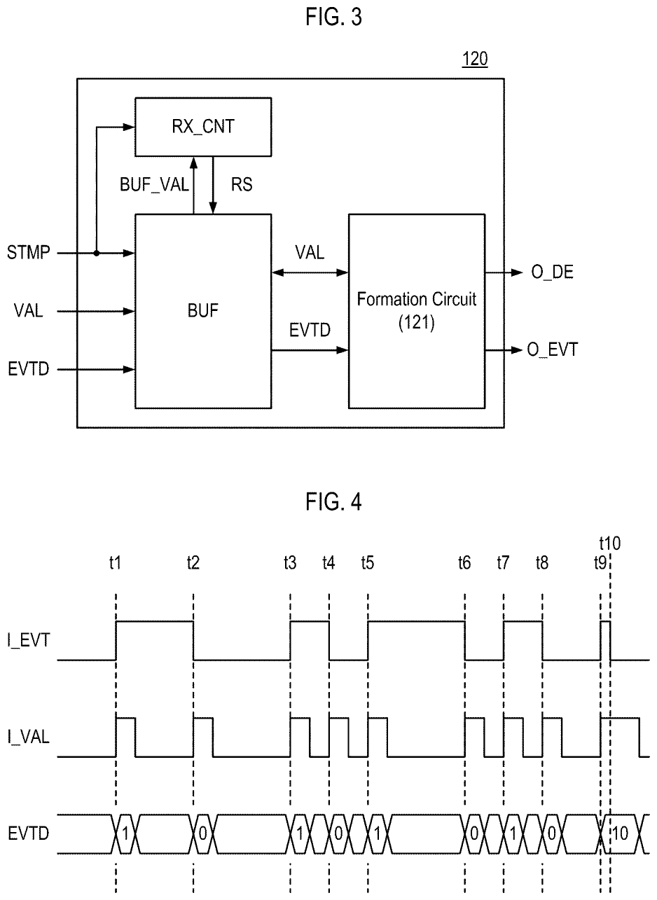

FIG. 3 is a block diagram of a receiver of FIG. 1, according to one or more embodiments.

Referring to FIG. 3, the receiver 120 may include a buffer BUF, a reception counter RX_CNT, and a formation circuit 121.

The buffer BUF may buffer the stamp signal STMP, the valid signal VAL, and the event data signal EVTD, which are received signals.

In certain embodiments, the buffer BUF may acquire (or generate) and output a buffer valid signal BUF_VAL. The buffer valid signal BUF_VAL may indicate the validity of the buffered signals. For example, the buffer BUF may acquire (or generate) the buffer valid signal BUF_VAL based on at least one of the stamp signal STMP, the valid signal VAL, or the event data signal EVTD. The buffered signals may be retrieved only during a valid period indicated by the buffer valid signal BUF_VAL. The buffer valid signal BUF_VAL may be provided to the reception counter RX_CNT.

The reception counter RX_CNT may be provided with (or receive) the above-described buffer valid signal BUF_VAL and the stamp signal STMP provided from the transmitter 110.

In certain embodiments, the reception counter RX_CNT may be initiated based on a first stamp signal STMP received first after the reset state is released in response to a reset signal. The reception counter RX_CNT be initiated from a value delayed by a predetermined value from the transmission counter value indicated by the first received stamp signal STMP.

The initiated reception counter RX_CNT may check whether both a first condition and a second condition are satisfied, while sequentially acquiring (or generating) reception counter values. The first condition is defined as whether the reception counter value corresponds to a valid period indicated by the buffer valid signal BUF_VAL, and the second condition is defined as whether the reception counter value is equal to the transmission counter value indicated by the stamp signal STMP. When both the first condition and the second condition are satisfied, the reception counter RX_CNT may acquire (or generate) a retrieval signal RS corresponding to the reception counter value. The retrieval signal RS indicates a retrieval timing of the retrieval operation of the buffer BUF (for example, a reception counter value at which both the first condition and the second condition are satisfied). The reception counter RX_CNT may transmit the retrieval signal RS to the buffer BUF.

The buffer BUF may perform a retrieval operation based on the retrieval signal RS. According to the above-described embodiments, the time point at which the reception counter RX_CNT is initiated may be adjusted to ensure the continuity of the retrieval operation. The buffer BUF may provide the retrieved stamp signal STMP, valid signal VAL, and event data signal EVTD to the formation circuit 121.

The formation circuit 121 may receive the valid signal VAL and the event data signal EVTD retrieved from the buffer BUF. The formation circuit 121 may acquire (or generate), decode an output event signal O_EVT based on the retrieved event data signal EVTD or acquire (generate or decode) an output data enable signal O_DE based on the valid signal VAL. For example, the continuity of the event data signal EVTD is ensured in the retrieval operation, so that the continuity of the output event signal O_EVT may also be ensured without data transfer delay.

FIG. 4 is a timing diagram of the operation of a transmitter according to one or more embodiments. Hereinafter, each time point ‘tx’ (where x is a positive integer) in the timing diagram represents a specific time point in a given drawing. Note that time points may be the same or different across drawings

Referring to FIG. 4, a timing diagram of the input event signal I_EVT (see FIGS. 1 and 2), the internal valid signal I_VAL (see FIG. 2), and the event data signal EVTD (see FIG. 2) is illustrated. At time t1, the input event signal I_EVT may transition from logic low to logic high. As an event (a change in logic level) occurs in the input event signal I_EVT, the internal valid signal I_VAL toggles once at time t1. In addition, for example, the event data signal EVTD may output ‘1’ to indicate that the event occurring at time t1 is a low-to-high transition.

At time t2, the input event signal I_EVT may transition from logic high to logic low. In response to the event occurring at time t2, the internal valid signal I_VAL toggles once at time t2. In addition, for example, the event data signal EVTD may output ‘0’ to indicate that the event occurring at time t2 is a high-to-low transition.

At each of times t3 to t8, whenever events occur sequentially in the input event signal I_EVT, a low-to-high transition or a high-to-low transition may occur, and the internal valid signal I_VAL may toggle with each event. In addition, the input event signal I_EVT may output a value indicating the type of event for each toggle period of the internal valid signal I_VAL.

For example, at times t9 and t10, consecutive events may occur. In the consecutive events, the internal valid signal I_VAL may exhibit a combined form of two consecutive pulses and the event data signal EVTD may output a consecutive value of ‘10’.

In the above-described embodiments, the output values of the event data signal EVTD are merely exemplary. Therefore, embodiments are not limited thereto. For example, a value indicating a low-to-high transition may be ‘0’, and a value indicating a high-to-low transition may be ‘1’. Alternatively, values other than ‘0’ and ‘1’ may be used.

According to the above-described embodiments, events occurring in the input event signal I_EVT may be indicated or identified through the internal valid signal I_VAL and the event data signal EVTD.

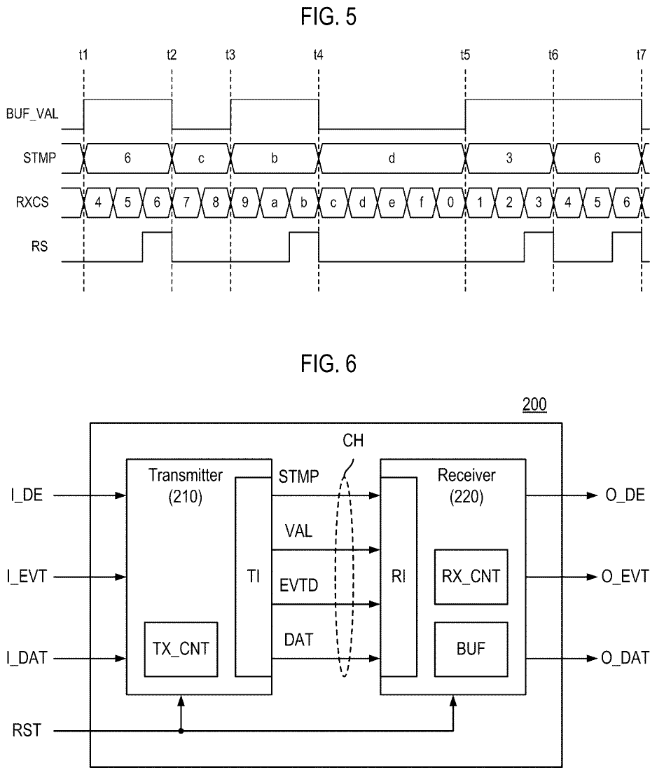

FIG. 5 is a timing diagram of the operation of a receiver according to one or more embodiments.

Referring to FIG. 5, the buffer valid signal BUF_VAL (see FIG. 3) may output a logic high when valid data is buffered in a buffer and output a logic low when no valid data is buffered in the buffer. Accordingly, the retrieval signal RS may toggle only during periods of t1 to t2, t3 to t4, and t5 to t7, during which the buffer valid signal BUF_VAL outputs a logic high.

The stamp signal STMP may output specific transmission counter values corresponding to the valid signal VAL. In FIG. 5, an example is provided in which the stamp signal STMP has a size of 4 bits, but embodiments are not limited thereto.

The reception counter signal RXCS may sequentially and repeatedly represent the reception counter values acquired (or generated) by the reception counter. In FIG. 5, an example is provided in which that the reception counter signal RXCS has a size of 4 bits, but embodiments are not limited thereto. For example, the reception counter signal RXCS may sequentially and repeatedly output values from 0 to f.

In certain embodiments, the reception counter signal RXCS may be delayed by a predetermined value compared to the transmission counter signal TXCS acquired (or generated) from the transmission counter.

The retrieval signal RS may toggle only when the buffer valid signal BUF_VAL indicates validity.

During the period of t1 to t2, the stamp signal STMP may output 6 and the buffer valid signal BUF_VAL may indicate validity. Therefore, the retrieval signal RS may toggle when the reception counter signal RXCS is 6.

During the period of t2 to t3, the buffer valid signal BUF_VAL indicate invalidity, so that a retrieval operation may not be performed.

During the period of the t3 to t4, the stamp signal STMP may output b and the buffer valid signal BUF_VAL may indicate validity. Therefore, the retrieval signal RS may toggle when the reception counter signal RXCS is b.

During the period t4 to t5, the buffer valid signal BUF_VAL indicates invalidity, so that a retrieval operation may not be performed. Although a reception counter signal RXCS corresponding to d output by the stamp signal STMP is present during the period of t4 to t5, a retrieval operation may not be performed.

During the period of t5 to t6, the stamp signal STMP may output 3 and the buffer valid signal BUF_VAL may indicate validity. Therefore, the retrieval signal RS may toggle when the reception counter signal RXCS is 3. During the period of t6 to t7, the stamp signal STMP outputs 6 and the buffer valid signal BUF_VAL may indicate validity. Therefore, the retrieval signal RS may toggle when the reception counter signal RXCS is 6.

According to the above-described embodiments, the receiver generates the retrieval signal RS based on the reception counter value indicated by the stamp signal STMP, so that the retrieval operation may be performed at a timing synchronized with the transmitter.

FIG. 6 is a block diagram of a transceiver according to some example embodiments. Hereinafter, detailed descriptions of repeated parts will be omitted to avoid redundancy.

Referring to FIG. 6, a transceiver 200 according to one or more embodiments may include a transmitter 210 and a receiver 220 connected to each other through a channel CH. In certain embodiments, the transmitter 210 may further include a transmission interface TI in addition to a transmission counter TX_CNT, and the receiver 220 may further include a reception interface RI in addition to a buffer and a reception counter RX_CNT.

The transmission interface TI may be switched to a reception interface RI when the transmitter 210 operates as a receiver 220. Similarly, the reception interface RI may be switched to a transmission interface TI when the receiver 220 operates as a transmitter 210. According to various examples, the transmission interface TI and the reception interface RI may be configured to perform functions or operations supported in a globally asynchronous locally synchronous (GALS) system, such as a handshake protocol, data serialization and/or deserialization, and synchronization between identical or different frequency domains. In a GALS system, a low-power operation using clock gating may be performed.

In certain embodiments, each of the transmission interface TI and the reception interface RI may include an asynchronous buffer. The asynchronous buffer included in the transmitter 210 may transmit signals at a frequency aligned with the operating clock of the transmitter 210. The asynchronous buffer included in the receiver 220 may transmit a frequency of a signal to be transmitted in synchronization with an operating clock of the transmitter 210.

The stamp signal STMP, the valid signal VAL, event data signal EVTD, and the data signal DAT may be transmitted and received through the transmission interface TI and reception interface RI.

The transmitter 210 may acquire (or generate) the stamp signal STMP, the valid signal VAL, and the event data signal EVTD based on the input data enable signal I_DE and an input event signal I_EVT according to the above-described embodiments and transmit the acquired (or generated) signals to the receiver 220 via the transmission interface TI.

The transmitter 210 may receive an input data signal I_DAT and a reset signal RST associated with the input event signal I_EVT. The input data signal I_DAT may include the above-described image data. The input event signal I_EVT may provide synchronization for the input data signal I_DAT, and the input data enable signal I_DE may indicate the validity of the input data signal I_DAT. A signal processed and/or transmitted through the transmission interface TI may be defined as a data signal DAT.

The reset signal RST may set or release a reset state of the transmitter 210 and receiver 220. When the reset signal RST transitions to a specific logic level (for example, logic high), the reset state may be released. The transmission counter TX_CNT of the transmitter 210 may be initiated with the release of the reset state.

The receiver 220 may receive the stamp signal STMP, the valid signal VAL, the event data signal EVTD, and the data signal DAT transmitted through the channel CH via the reception interface RI. The receiver 220 may buffer the received signals in the buffer BUF. The reception counter RX_CNT of the receiver 220 may be based on the first stamp signal STMP received first after releasing the reset state according to the reset signal RST. Data transmission delay across the transmit interface TI, the channel CH, and the receive interface RI may be mitigated by buffering signals and adjusting initiation timing of the reception counter RX_CNT.

In addition, the buffer BUF is provided independently of the asynchronous buffer configured to support the GALS system, so that a depth of the buffer BUF may be set or defined to retrieve the input event signal I_EVT sufficiently and continuously.

After the initiation of the reception counter RX_CNT, the receiver 220 may perform a retrieval operation on the buffer BUF at each time point corresponding to the reception counter value corresponding to the stamp signal STMP. The receiver 220 may acquire (generate, or decode) the output data enable signal O_DE and the output event signal O_EVT based on the retrieved valid signal VAL and the event data signal EVTD. In addition, the receiver 220 may acquire (generate, or decode) and output the output data signal O_DAT based on the retrieved data signal DAT.

In signal transmission and reception of a GALS system-based transceiver interface using an asynchronous buffer AB, data transfer delays may not be constant. Therefore, it may be difficult to transmit continuous video signals. In the case of the transceiver 200 according to the above-described embodiments, the continuity of the retrieval operation may be ensured to prevent an issue of data transfer delay. As a result, continuous video signals may be transmitted and received even through a transceiver interface using an asynchronous buffer AB, enabling low-power transmission and reception of continuous video signals.

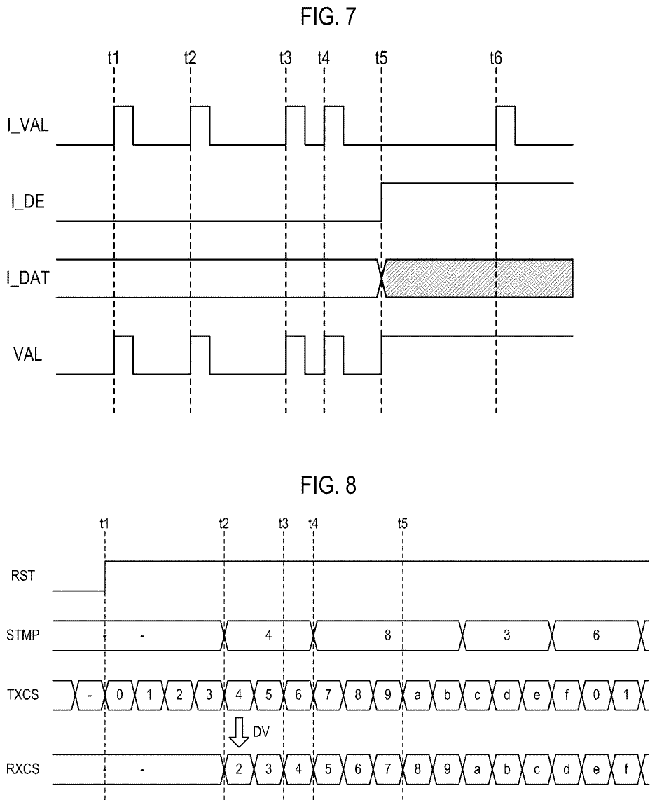

FIG. 7 is a timing diagram of a valid signal acquisition operation of the transmitter of FIG. 6, according to one or more embodiments.

Referring to FIG. 7, the internal valid signal I_VAL may toggle at each of times t1 to t6 to indicate the occurrence of an event in the input event signal. The input data enable signal I_DE may indicate that the input data signal I_DAT is valid from time t5.

The valid signal VAL may be defined as an OR operation between the internal valid signal I_VAL and the input data enable signal I_DE. Accordingly, the valid signal VAL may toggle at each of time points t1 to t4, similarly to the internal valid signal I_VAL. From time t5 at which the input data enable signal I_DE transitions from logic low to logic high, the valid signal VAL may also transition from logic low to logic high.

FIG. 8 is an operation timing diagram of counters in the transceiver of FIG. 6 according to one or more embodiments.

Referring to FIG. 8, at time t1, the reset signal RST may transition from logic low to logic high to indicate that the reset state has been released. With the release of the reset state, the transmission counter may be initiated from time t1. Accordingly, the transmission counter signal TXCS may sequentially output 0 to f from time t1.

At time t2, the first stamp signal STMP may be output. According to the above-described embodiments, the reception counter may be initiated from ‘2’ that is a value delayed by a predetermined value DV from the transmission counter value ‘4’ indicated by the first stamp. Accordingly, the reception counter signal RXCS may sequentially output 2 to f from time t2.

During the period of t3 to t4 where the reception counter signal RXCS outputs ‘4’ indicated by the stamp signal STMP, a retrieval operation may be performed on the buffer.

The stamp signal STMP outputs ‘8’ from time t4, and a retrieval operation may be performed on the buffer at time t5 at which the reception counter signal RXCS also outputs ‘8’.

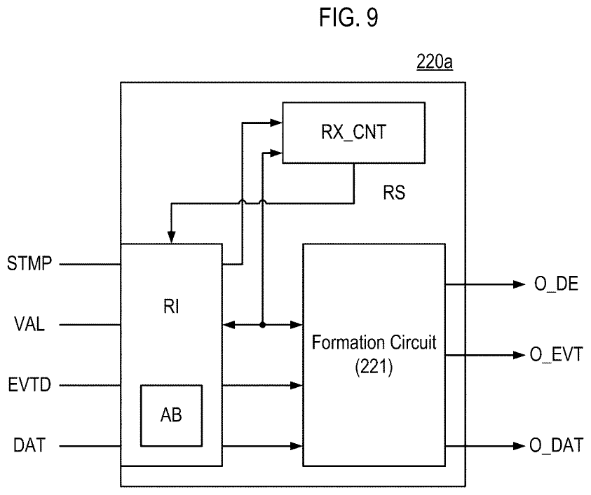

FIG. 9 is a block diagram of a receiver according to one or more embodiments.

Referring to FIG. 9, a receiver 220a according to one or more embodiments may include a reception interface RI, a reception counter RX_CNT, and a formation circuit 221. For example, a buffer may be omitted in the receiver according to the above-described embodiments (see FIGS. 1, 3, and 6). Due to the omission of the buffer, the receiver 220a may buffer received signals based on an asynchronous buffer AB included in the reception interface RI. For example, a stamp signal STMP, a valid signal VAL, an event data signal EVTD, and a data signal DAT may be buffered in the asynchronous buffer AB. For example, the asynchronous buffer AB may have a FIFO structure.

The stamp signal STMP and the valid signal VAL, output from the reception interface RI, may be provided to the reception counter RX_CNT. The reception counter RX_CNT may be initiated based on the stamp signal STMP, acquire (or generate) a retrieval signal RS based on the valid signal VAL and the stamp signal STMP after the initiation, and provide the acquired retrieval signal RS to the asynchronous buffer AB.

The asynchronous buffer AB may perform the same retrieval operation as the buffer according to the above-described embodiments (see FIGS. 1, 3, and 6). The asynchronous buffer AB may retrieve buffered signals at each period at which the retrieval signal RS toggles and provide the retrieved signals to the formation circuit 221.

In certain embodiments, the receiver 220a may replace the receiver of FIG. 6.

The receiver 220a may use the asynchronous buffer AB within the reception interface RI as it is, eliminating the need to configure an additional buffer.

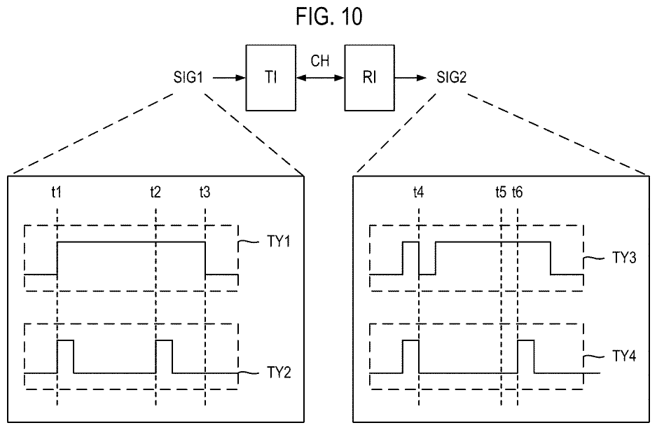

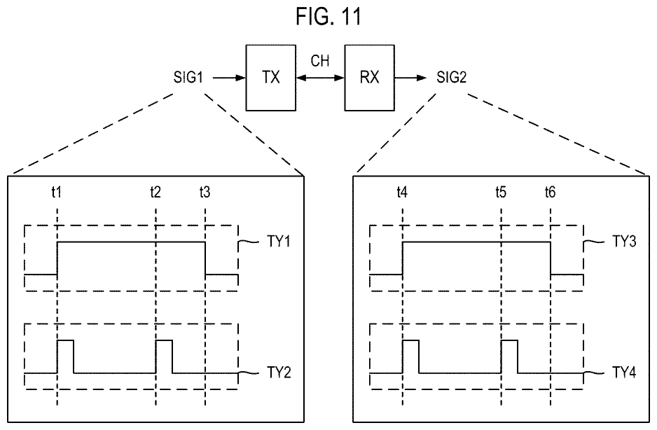

FIG. 10 is a timing diagram of signals transmitted and received through an exemplary channel, and FIG. 11 is a timing diagram of signals transmitted and received through a transceiver according to one or more embodiments.

Referring to FIG. 10, a first signal SIG1 transmitted through the transmission interface TI may be received through a reception interface RI via the channel CH. In the case of first type TY1, the same logic level may be maintained during the period of t1 to t3. In the case of second type TY2, toggling may occur at times t1 and t2.

When a distance of the channel CH is sufficiently long, a data transfer delay may occur in a second signal SIG2, a received signal, as illustrated in the drawing. For example, in the case of third type TY3, some signals may be lost at time t4. In addition, in the case of fourth type TY4, a pulse expected to arrive at time t5 may be delayed to time t6.

Referring to FIG. 11, a transmitter TX and a receiver RX according to one or more embodiments may be configured as the transmitter and the receiver according to the above-described embodiments (see FIGS. 1 to 9) or operate according to the above-described embodiments (see FIGS. 1 to 9). The transmitter TX and receiver RX may ensure the continuity of a retrieval operation by buffering signals and adjusting initiation timing of the reception counter RX_CNT according to the above-described embodiments. As a result, a signal of the third type TY3 may maintains identity with a signal of the first type TY1, and a signal of the fourth type TY4 may maintains identity with a signal of the second type TY2.

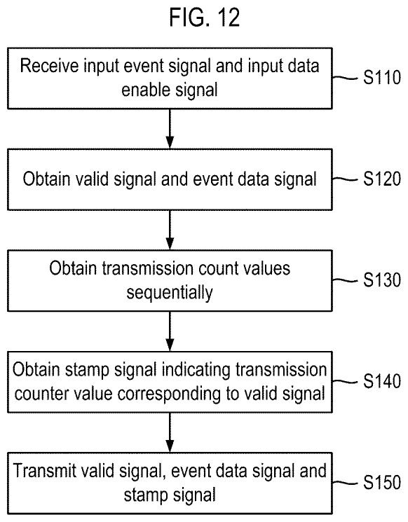

FIG. 12 is a flowchart illustrating a method of operating a transmitter according to one or more embodiments.

Referring to FIG. 12, in operation S110, the transmitter may receive an input event signal and an input data enable signal. For example, the input event signal and the input data enable signal may be transmitted from a module, other than a unit module including the transmitter. Alternatively, the transmitter may also receive an input data signal associated with the input data enable signal.

In operation S120, the transmitter may acquire a valid signal and an event data signal based on a rising edge and a falling edge of the input event signal. For example, the transmitter may identify each edge and acquire a valid signal that toggles for each edge. For example, the transmitter may acquire an event data signal including a value indicating the type of edge.

In operation S130, the transmitter may sequentially acquire transmission counter values. For example, operation S130 may be initiated with the release of a reset state, independently of operations S110 and S120.

In operation S140, the transmitter may acquire a stamp signal indicating a transmission counter value corresponding to the valid signal, among the transmission counter values acquired in operation S130. Operation S140 may be repeatedly performed whenever the valid signal indicates that at least one of the input event signal or the input data enable signal is valid.

In operation S150, the transmitter may transmit the valid signal, the event data signal, and the stamp signal to the receiver. For example, the transmitter may perform a transmission operation through the transmission interface (see FIG. 6).

A stamp signal for the receiver to synchronize timing may be provided through the method according to the above-described embodiments.

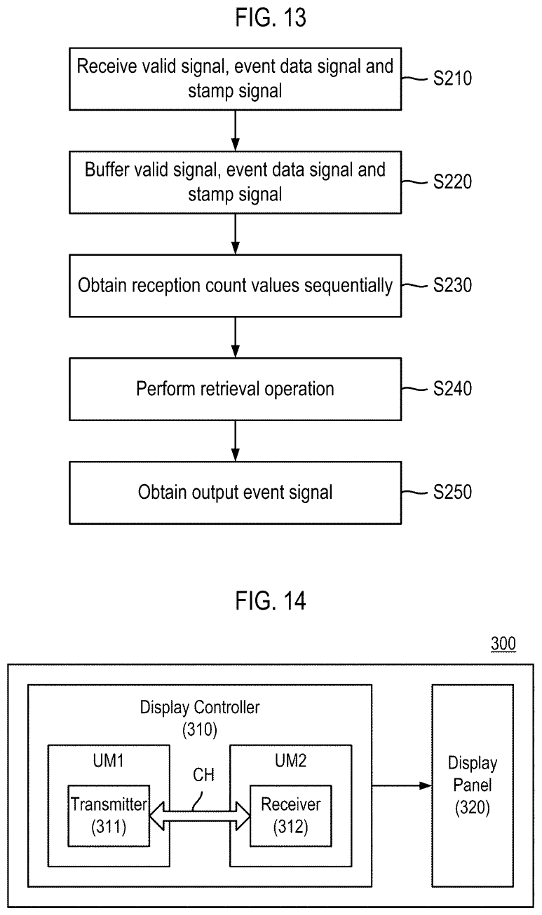

FIG. 13 is a flowchart illustrating a method of operating a receiver according to one or more embodiments.

Referring to FIG. 13, in operation S210, the receiver may receive a valid signal, an event data signal, and a stamp signal from the transmitter. For example, the receiver may perform a reception operation through the reception interface (see FIG. 6).

In operation S220, the receiver may buffer the valid signal, the event data signal, and the stamp signal. For example, the receiver may perform operation S220 on the buffer or asynchronous buffer according to the above-described embodiments.

In operation S230, the receiver may sequentially acquire reception counter values. In certain embodiments, operation S230 may be initiated based on a first stamp signal after a reset signal for the receiver transitions to a specific logic level. For example, operation S230 may be initiated from a value delayed by a predetermined value from the transmission counter value indicated by the first stamp signal.

In operation S240, the receiver may perform a retrieval operation at a time point corresponding to a reception counter value corresponding to the stamp signal, among the reception counter values.

In operation S250, the receiver may acquire an output event signal based on the event data signal retrieved through operation S240.

The method of operating the receiver according to the above-described embodiments may ensure the continuity of the output event signal functioning as a continuous video signal.

FIG. 14 is a diagram illustrating a display device according to one or more embodiments.

Referring to FIG. 14, a display device 300 may include a display controller 310 and a display panel 320.

The display controller 310 may control the overall operation of the display device 300. The display controller 310 may generate image data to be displayed on the display panel 320 and control commands for controlling the display device 300. For example, the control commands may include setting information on luminance, gamma, frame frequency, operation mode, or the like, of a display driving circuit. The display controller 310 may process image data based on a clock signal and/or various synchronization signals. The image data may include frame data corresponding to each of a plurality of frames.

In certain embodiments, the display controller 310 may be implemented as various types of processors such as a central processing unit (CPU), a graphics processing unit (GPU), a microprocessor, a multimedia processor, or an application processor. Alternatively, the display controller 310 may be implemented as an integrated circuit (IC) or a system-on-chip (SoC).

The display controller 310 may include a first unit module UM1 including a transmitter according to the above-described embodiments and a second unit module UM2 including a receiver according to the above-described embodiments. The first unit module UM1 and the second unit module UM2 may be connected to each other through a channel according to the above-described embodiments. Each unit module may perform various functions to process image data.

The transmitter and the receiver may be implemented as the transmitter and the receiver according to the above-described embodiments (see FIGS. 1 to 13) or operate according to the above-described embodiments (see FIGS. 1 to 13). The transmitter may acquire (or generate) and transmit signals (for example, a stamp signal, a valid signal, an event data signal, or the like) indicating events of continuous video signals used to process image data for driving the display panel 320. The receiver may buffer the received signals and serve to ensure the continuity of a retrieval operation on the buffered signals. For example, the receiver may perform the retrieval operation based on a stamp signal for timing synchronization or adjust the initiation timing of a reception counter used in the receiver.

The display controller 310 may convert image data into an analog signal for driving the display panel 320 and provide the converted analog signal to the display panel 320.

The display panel 320 may be a display on which actual images are displayed and may be one of various display devices, receiving electrically transmitted image signals to display two-dimensional images, such as a thin film transistor-liquid crystal display (TFT-LCD), an organic light emitting diode (OLED) display, a field emission display, or a plasma display panel (PDP).

As set forth above, according to one or more embodiments, a receiver for ensuring continuity, a transceiver including the same, and a method may be provided.

While various embodiments have been shown and described above, it will be apparent to those skilled in the art that modifications and variations could be made without departing from the scope of the present inventive concept as defined by the appended claims.

What is claimed is:

1. A transceiver comprising:
a transmitter configured to:
acquire a valid signal indicating occurrence of a rising edge and a falling edge of an input event signal and an event data signal indicating a type of edge, based on the rising edge and the falling edge;
acquire a stamp signal indicating a transmission counter value corresponding to the valid signal, among transmission counter values; and
transmit the valid signal, the event data signal, and the stamp signal; and
a receiver configured to:
buffer the valid signal, the event data signal, and the stamp signal in a buffer;
acquire a reception counter value corresponding to the stamp signal, among reception counter values; and
perform a retrieval operation on the buffer at a time point corresponding to the reception counter value.

2. The transceiver of claim 1, wherein:
the buffer is configured with a first-in first-out (FIFO) structure.

3. The transceiver of claim 1, wherein:
the transmitter comprises a transmission counter configured to sequentially acquire the transmission counter values and initiated based on a reset signal, common to the transmitter and the receiver, transitioning to a specific logic level.

4. The transceiver of claim 3, wherein:
the transmission counter is configured to output the stamp signal.

5. The transceiver of claim 1, wherein:
the receiver comprises a reception counter configured to sequentially acquire the reception counter values and initiated based on a first stamp signal after a reset signal, common to the transmitter and the receiver, transitions to a specific logic level.

6. The transceiver of claim 5, wherein:
the reception counter is configured to be initiated from a value delayed by a predetermined value from the transmission counter value indicated by the first stamp signal.

7. The transceiver of claim 1, wherein:
the receiver comprises the buffer.

8. The transceiver of claim 1, wherein:
the receiver is configured to acquire an output event signal based on the event data signal retrieved through the retrieval operation.

9. The transceiver of claim 5, wherein:
the reception counter is configured to:
acquire a retrieval signal indicating retrieval timing of the retrieval operation; and
transmit the retrieval signal to the buffer.

10. The transceiver of claim 1, wherein:
the transmitter is configured to:
receive an input data signal associated with the input event signal and an input data enable signal indicating validity of the input data signal;
acquire an internal valid signal toggling at the rising edge and the falling edge; and
acquire the valid signal based on an OR operation on the input data enable signal and the internal valid signal.

11. A receiver comprising:
a reception interface configured to receive:
a valid signal indicating occurrence of a rising edge and a falling edge of an input event signal,
an event data signal indicating a type of edge, and
a stamp signal indicating a transmission counter value corresponding to the valid signal;
a reception counter configured to sequentially acquire reception counter values; and
a buffer configured to:
buffer the valid signal, the event data signal, and the stamp signal; and
perform a retrieval operation at a time point corresponding to a reception counter value corresponding to the stamp signal, among the reception counter values.

12. The receiver of claim 11, wherein:
the buffer is configured with a first-in first-out (FIFO) structure.

13. The receiver of claim 11, wherein:
the reception counter is configured to be initiated based on a first stamp signal after a reset signal for the receiver transitions to a specific logic level.

14. The receiver of claim 13, wherein:
the reception counter is configured to be initiated from a value delayed by a predetermined value from the transmission counter value indicated by the first stamp signal.

15. The receiver of claim 11, wherein:
the reception counter is configured to:
acquire a retrieval signal indicating retrieval timing of the retrieval operation, and
transmit the retrieval signal to the buffer.

16. The receiver of claim 11, further comprising:
a formation circuit configured to acquire an output event signal based on the event data signal retrieved through the retrieval operation.

17. A method of a receiver, the method comprising:
receiving a valid signal indicating occurrence of a rising edge and a falling edge of an input event signal, an event data signal indicating a type of edge, and a stamp signal indicating a transmission counter value corresponding to the valid signal;
buffering the valid signal, the event data signal, and the stamp signal;
sequentially acquiring reception counter values; and
performing a retrieval operation at a time point corresponding to a reception counter value corresponding to the stamp signal, among the reception counter values.

18. The method of claim 17, wherein:
the acquiring of the reception counter values is initiated based on a first stamp signal after a reset signal for the receiver transitions to a specific logic level.

19. The method of claim 18, wherein:
the acquiring of the reception counter values is initiated from a value delayed by a predetermined value from the transmission counter value indicated by the first stamp signal.

20. The method of claim 17, further comprising:
acquiring an output event signal based on the event data signal retrieved through the retrieval operation.
